(19) United States
(12) Patent Application Publication
(10) Pub. No.: US 2013/0070769 A1
(43) Pub. Date: Mar. 21, 2013

(54) METHOD AND SYSTEM FOR IDENTIFICATION OF PACKET GATEWAYS SUPPORTING DIFFERENT SERVICE TYPES

(71) Applicants: Mohamed Khalil, Murphy, TX (US); Ahmad Muhanna, Richardson, TX (US); Haseeb Akhtar, Garland, TX (US)

(72) Inventors: Mohamed Khalil, Murphy, TX (US); Ahmad Muhanna, Richardson, TX (US); Haseeb Akhtar, Garland, TX (US)

(21) Appl. No.: 13/618,354

(22) Filed: Sep. 14, 2012

Related U.S. Application Data
(63) Continuation of application No. 12/989,759, filed on Oct. 26, 2010.
Application No. 12/989,759 is a continuation of application No. PCT/US2009/002640, filed on Apr. 30, 2009.
(60) Provisional application No. 61/049,662, filed on May 1, 2008.

(51) Int. Cl. H04L 12/28

(52) U.S. Cl. 370/392

(57) ABSTRACT

The present invention provides a method and system for identification of the different packet gateways that support different types of services on their packet data networks. The method and system provides identification and addressing information to user equipment for one or more packet gateways that support different types of services, sometimes called QoS services. The identification and addressing information for the one or more packet gateways is provided in the present invention by and through a DNS server or an AAA server depending on the network architecture and the IP version supporting the communications with the mobile node.

### RELATED APPLICATION DATA

This application is related to Provisional Patent Application Ser. No. 61/049,662 filed on May 1, 2008, and priority is claimed for this earlier filing under 35 §119(e). The Provisional Patent Application is also incorporated by reference into this utility patent application.

### TECHNICAL FIELD OF THE INVENTION

A method and system for the identification of packet gateways that support different types (QoS) services.

### BACKGROUND OF THE INVENTION

IP-based mobile system includes at least one mobile node on a wireless communication system. The term “mobile node” includes a mobile communication unit, and, in addition to the mobile node, the communication system has a home network and a foreign network. The mobile node may change its point of attachment to these networks, but the mobile node will always be associated with a single home network for IP addressing purposes. The home network has a home agent and the foreign network has a foreign agent—both of which control the routing of information packets into and out of their network.

The mobile node, home network, and foreign network may be called other names depending on the nomenclature used on any particular network configuration or communication system. For instance, a “mobile node” is sometimes referred to as user equipment, mobile unit, mobile terminal, mobile device, or similar names depending on the nomenclature adopted by particular system providers. A “mobile node” encompasses PC's having cabled (e.g., telephone line (“twisted pair”), Ethernet cable, optical cable, and so on) connectivity to the wireless network, as well as wireless connectivity directly to the cellular network, as can be experienced by various makes and models of mobile terminals (“cell phones”) having various features and functionality, such as Internet access, e-mail, messaging services, and the like. The term “mobile node” also includes a mobile communication unit (e.g., mobile terminal, “smart phones,” nomadic devices such as laptop PCs with wireless connectivity).

A home agent may be referred to as a Home Agent, Home Mobility Manager, Home Location Register, and a foreign agent may be referred to as a Foreign Agent, Serving Mobility Manager, Visited Location Register, and Visiting Serving Entity. Foreign networks can also be called serving networks. The terms Mobile Node, Home Agent and Foreign Agent are not meant to be restrictively defined, but could include other mobile communication units or supervisory routing devices located on the home or foreign networks.

There are different types of wireless communication systems, such as general packet radio service (GPRS), global system for mobile (GSM)/enhanced data rates for GSM evolution (EDGE) radio access network (GERAN), and long term evolution (LTE) evolved universal terrestrial radio access network (EUTRAN). LTE/EUTRAN system has a different physical layer and a different architecture from those systems preceding it, i.e., GPRS, GERAN, or UTRAN. Different types and levels of service are provided on the communications network by and through different types of packet data networks. Because different types of services are often offered through different packet data networks, the mobile node may need to access different types of services through different packet gateways associated with different packet data networks. It would be beneficial to have a method and system that would support the identification of the different packet gateways that support different types of services on their packet data networks.

### SUMMARY OF THE INVENTION

The present invention provides a method and system for identification of the different packet gateways that support different types of services on their packet data networks. The method and system provides identification and addressing information to user equipment for one or more packet gateways that support different types of services, sometimes called QoS services. The identification and addressing information for the one or more packet gateways is provided in the present invention by and through a DNS server or an AAA server depending on the network architecture and the IP version supporting the communications with the mobile node.

### BRIEF DESCRIPTION OF THE DRAWINGS

The objects and features of the invention will become more readily understood from the following detailed description and appended claims when read in conjunction with the accompanying drawings in which like numerals represent like elements and in which:

FIG. 1 is a mobile IP-based communication system showing the user equipment, the DNS server, AAA server, serving gateway, and packet gateways coupled to different packet data networks,

FIG. 2 is an addressing and identification protocol in Layer 3 using a DNS server with IPv4 protocols,

FIG. 3 is an addressing and identification protocol in Layer 3 using a DNS server with IPv6 protocols,

FIG. 4 is a addressing and identification protocol in Layer 3 using a AAA server with IPv4 protocols,

FIG. 5 is an addressing and identification protocol in Layer 3 using a AAA server with IPv6 protocols,

FIG. 6 is an addressing and identification protocol in Layer 2 using a DNS server and AAA server with IPv4 protocols, and,

FIG. 7 is an addressing and identification protocol in Layer 2 using a DNS server and AAA server with IPv4 protocols.

### DETAILED DESCRIPTION OF THE PREFERRED EMBODIMENTS

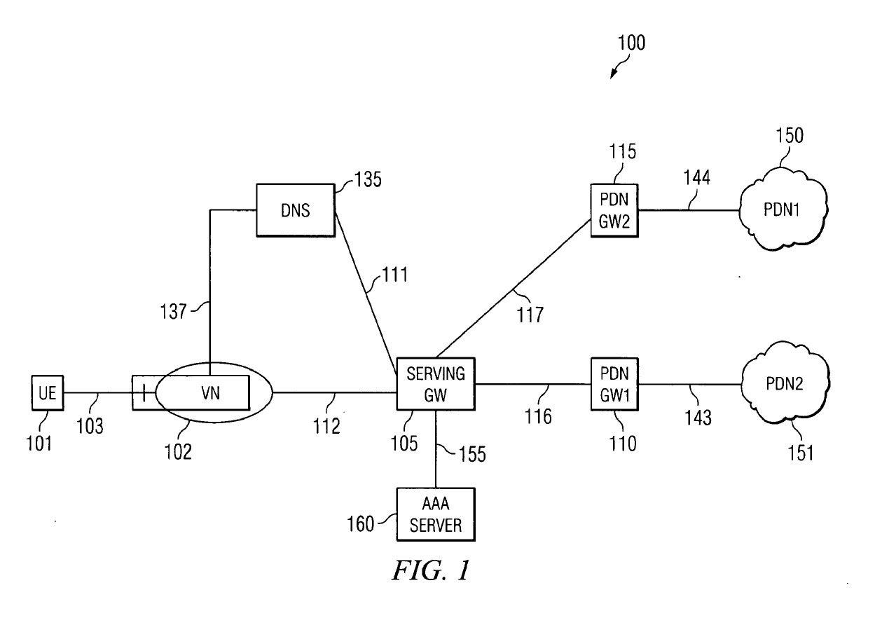

Referring to FIG. 1, the network 100 shows the various network components involved with the connection of the user equipment 101 to the packet data networks PDN1 150 and/or PDN2 151. In FIG. 1, the present invention proposes a solution for providing identification and addressing information for the user equipment 101 to track different services from different packet data network gateways as shown in the communication system 100. When referred to hereafter, the terminology user equipment (UE) includes, but is not limited to, a mobile station, a fixed or mobile subscriber unit, a pager, a cellular telephone, a personal digital assistant (PDA), a computer, or any other type of user device capable of operating in a wireless environment.

The user equipment 101 is coupled to a visited network 102 through connection 103, which can be composed of a wireless radio network connection. The visited network 102 is coupled to the serving gateway 105 through connection 112, and the visited network 102 is also coupled to a domain name service server 135 through connection 137.

The serving gateway 105 is coupled to the domain name service server 135 through connection 137, and the serving gateway 105 is coupled to an AAA server 160 through connection 155. The serving gateway 105 is also coupled to PDN Gateway 1 110 and PDN Gateway 2 115 through connections 116 and 117, respectively. The DNS server 135 and the AAA server 160 may also be connected to the system through a home network and/or home agent (not shown), sometimes called an HRPN Access Node and/or PDSN server. The PDN Gateway 1 110 and PDN Gateway 2 115 are coupled to the multiple PDN networks 150 and 151, which are coupled by connections 143 and 144, respectively. It is the determination of addresses associated with these PDN gateways 115 and/or 110 that is central to the present invention.

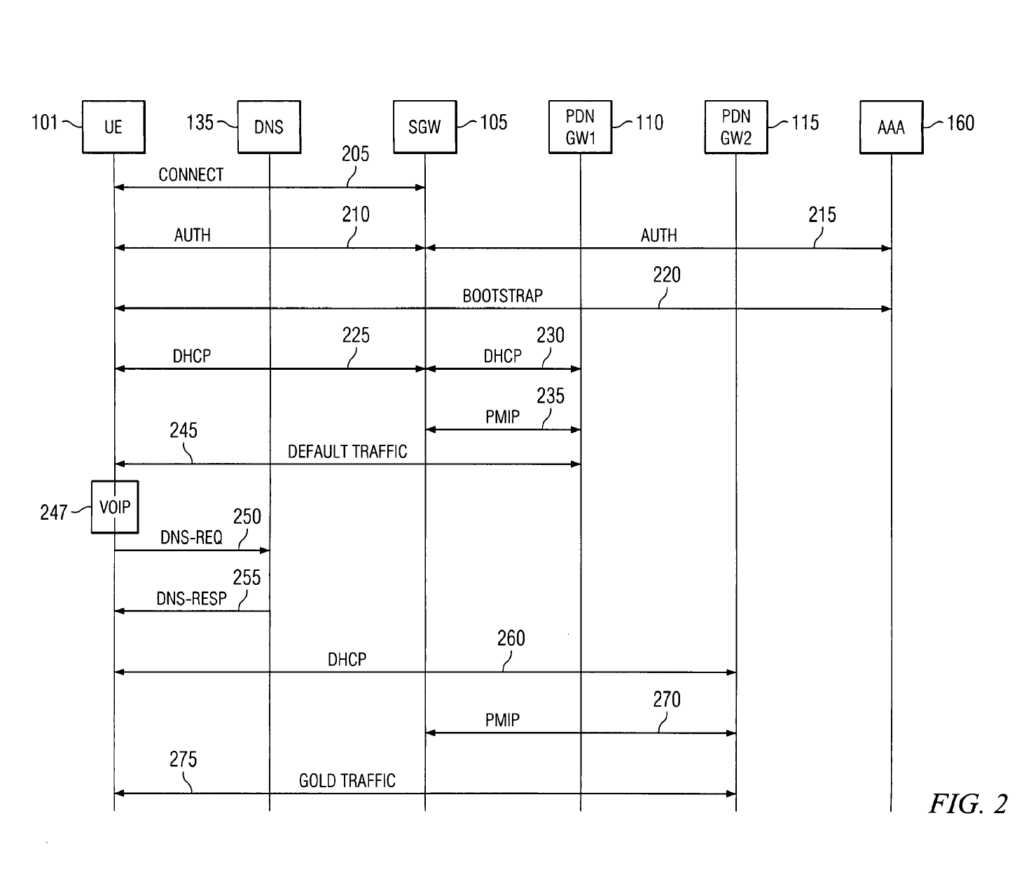

In FIG. 2, the identification and address information protocol is operated in Layer 3 using IPv6 messaging protocols, and is shown starting at step 205 when the user equipment 101 establishes its connections with the serving gateway 105. After step 205, the user equipment 101 is authenticated in step 210 by a communication to the serving gateway 105, and then step 215 from the serving gateway to the AAA server 160.

A bootstrapping step 220 is performed between the user equipment 101 and the AAA server 160 during the attachment procedure where the identification and address information for the default packet data network gateway PDN GW1 110 is provided to the user equipment 101. This will be the “best effort” type of service supported for the user equipment 101. This PDN gateway GW1 will support the default quality of service or the default type of service for user equipment communications.

The user equipment 101 will transmit a DHCP communication procedure with the serving gateway 105 in step 225, and the serving gateway 105 will engage with the packet data network PDN GW1 110 as the connection for the default services to be provided to the user equipment in step 230. A PMIP exchange between the serving gateway 105 and the packet data network PDN GW1 110 is conducted in step 235, and default traffic is exchanged using the default quality or type of service in step 245.

A voice call is initiated in step 247, and a different quality of service or type of service may be requested in the voice call. The user equipment 101 transmits a DNS request message to the DNS server 135 in step 250, and the DNS server 135 transmits a DNS response message to the user equipment in step 155. The DNS request message in step 250 requests the address and identification information for the packet data network gateway PDN GW2 115 that supports various new quality of service or type of service to be made available to the user equipment 101, and the DNS response message in step 255 provides the user equipment with that address and identification information for those quality or types of services (e.g. VoIP, video streaming, video IP, real video, etc.).

The DNS server 135 operates using RFC 5026 protocols, which means the mobile node is configured with the Fully Qualified Domain Name of the Home Agent. As an example, the Mobile Node could be configured with the name “ha1.example.com”, where “example.com” is the domain name of the MSP granting the mobility service. The mobile node constructs a DNS request by setting the QNAME to the name of the home agent. The request has QTYPE set to “AAA” so that the DNS server 135 sends the IPv4 address of the home agent.

The user equipment 101 uses the address and identification information received in step 255 to communicate with the packet data network gateway PDN GW2 115 in the DHCP message transmissions at step 260. A PMIP message exchange between the serving gateway 105 and the packet data network PDN GW2 115 is conducted in step 270, and new traffic is exchanged using the new quality of service or type of service in step 275.

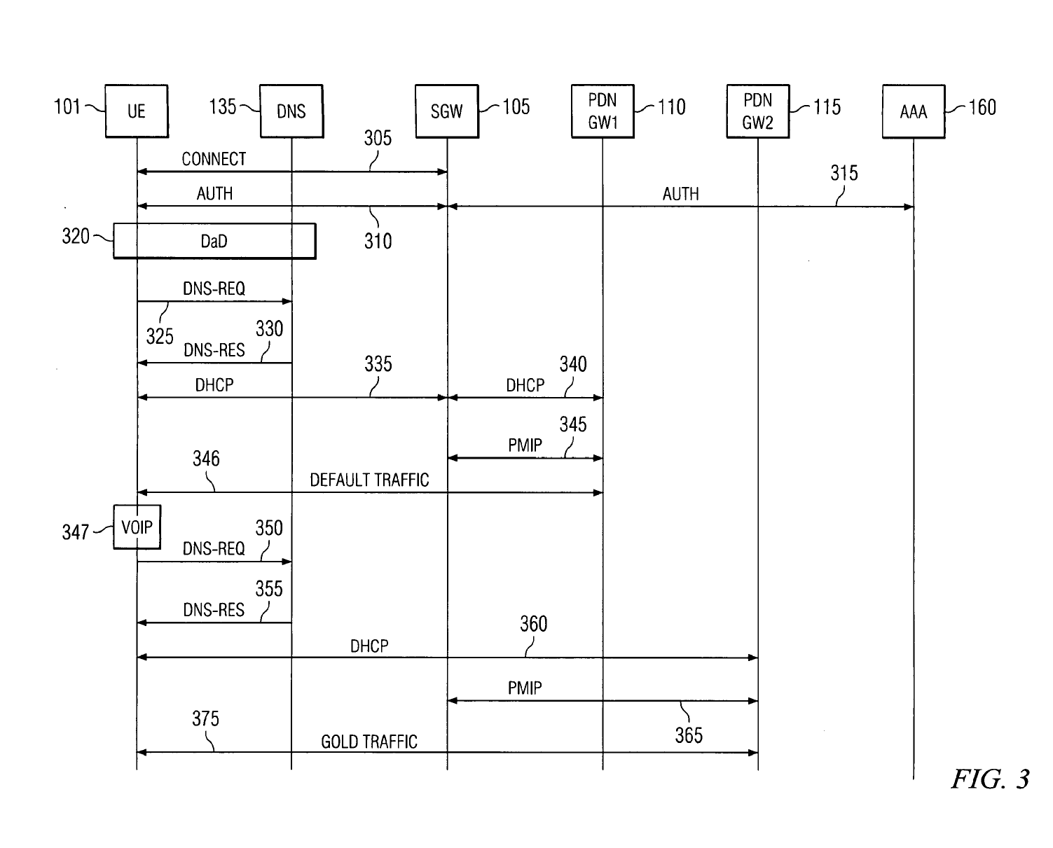

In FIG. 3, the identification and address information protocol is operated in Layer 3 using IPv6 messaging protocols, and is shown starting at step 305 when the user equipment 101 establishes its connections with the serving gateway 105. After step 305, the user equipment 101 is authenticated in step 310 by a communication to the serving gateway 105, and then step 315 from the serving gateway to the AAA server 160. A Local Address DaD procedure is engaged at step 220 between the user equipment 101 and the DNS server 135 after the authentication steps 310 and 315.

The user equipment 101 transmits a DNS request message to the DNS server 135 in step 325, and the DNS server 135 transmits a DNS response message to the user equipment in step 330. The DNS request message in step 325 requests the address and identification information for the packet data network gateway PDN GW1 110 that supports the default quality of service or type of service to be made available to the user equipment 101, and the DNS response message in step 330 provides the user equipment with that address and identification information for those default quality or types of services.

The DNS server 135 operates using RFC 5026 protocols, which means the mobile node is configured with the Fully Qualified Domain Name of the Home Agent. As an example, the Mobile Node could be configured with the name “ha1.example.com”, where “example.com” is the domain name of the MSP granting the mobility service. The mobile node constructs a DNS request by setting the QNAME to the name of the home agent. The request has QTYPE set to “AAAA” so that the DNS server 135 sends the IPv6 address of the home agent.

The user equipment 101 will transmit a DHCP communication procedure with the serving gateway 105 in step 335, and the serving gateway 105 will engage with the packet data network PDN GW1 110 as the connection for the default services to be provided to the user equipment in step 340. A PMIP exchange between the serving gateway 105 and the packet data network PDN GW1 110 is conducted in step 345, and default traffic is exchanged using the default quality or type of service in step 346.

A voice call is initiated in step 347, and a different quality of service or type of service may be requested in the voice call. The user equipment 101 transmits a DNS request message to the DNS server 135 in step 350, and the DNS server 135 transmits a DNS response message to the user equipment in step 355. The DNS request message in step 350 requests the address and identification information for the packet data network gateway PDN GW2 115 that supports various new quality of service or type of service to be made available to the user equipment 101, and the DNS response message in step 355 provides the user equipment with that address and identification information for those quality or types of services (e.g. VoIP, video streaming, video IP, real video, etc.).

The user equipment 101 uses the address and identification information received in step 355 to communicate with the packet data network gateway PDN GW2 115 in the DHCP message transmissions at step 360. A PMIP message exchange between the serving gateway 105 and the packet data network PDN GW2 115 is conducted in step 365, and new traffic is exchanged using the new quality of service or type of service in step 375.

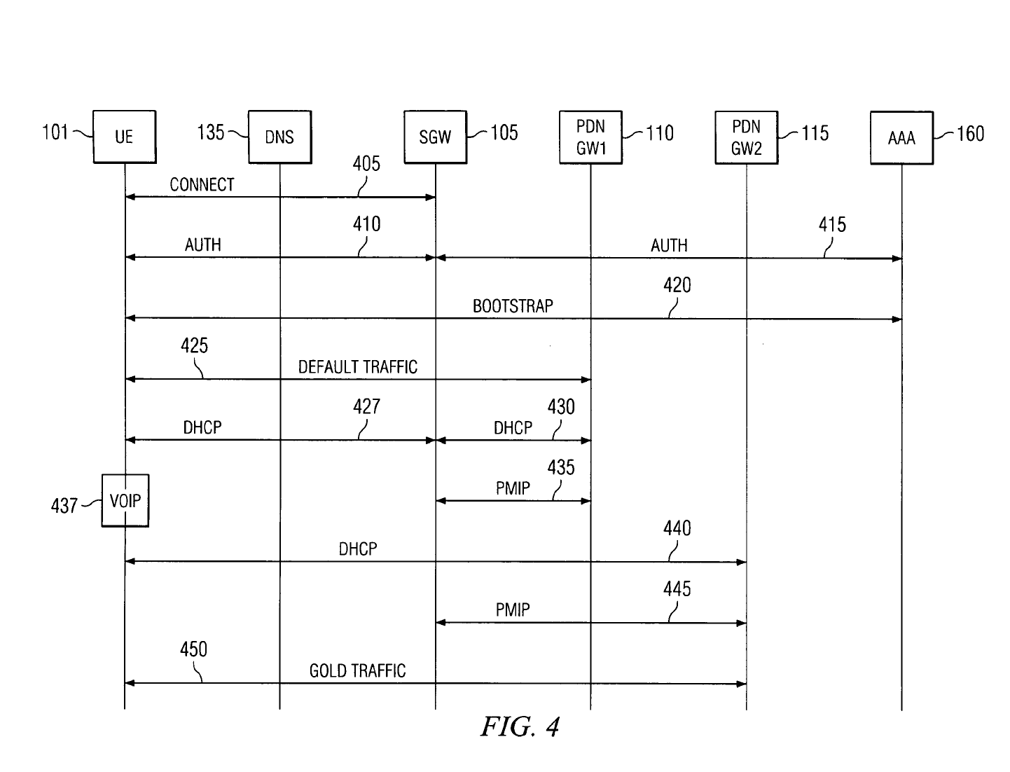

In FIG. 4, the identification and address information protocol is operated in Layer 3 using IPv4 messaging protocols, and is shown starting at step 405 when the user equipment 101 establishes its connections with the serving gateway 105. After step 405, the user equipment 101 is authenticated in step 410 by a communication to the serving gateway 105, and then step 415 from the serving gateway to the AAA server 160.

A bootstrapping step 420 is performed between the user equipment 101 and the AAA server 160 during the attachment procedure where the identification and address information for the default packet data network gateway PDN GW1 110 is provided to the user equipment 101. This will be the “best effort” type of service supported for the user equipment 101. This PDN gateway GW1 will support the default quality of service or the default type of service for user equipment communications. In addition to the default addressing and identification information, the bootstrapping step 420 will also provide the address and identification information for the packet data network gateway PDN GW2 115 that supports various new quality of service or type of service to be made available to the user equipment 101 (e.g. VoIP, video streaming, video IP, real video, etc.).

In step 425, default traffic is exchanged between the user equipment 101 and the packet data network PDN GW1 110 using the default quality or type of service. The user equipment 101 will transmit a DHCP communication procedure with the serving gateway 105 in step 427, and the serving gateway 105 will engage with the packet data network PDN GW1 110 as the connection for the default services to be provided to the user equipment in step 430. A PMIP exchange between the serving gateway 105 and the packet data network PDN GW1 110 is conducted in step 435.

A voice call is initiated in step 437, and a different quality of service or type of service may be requested in the voice call. The user equipment 101 uses the address and identification information received from the AAA server 160 to communicate with the packet data network gateway PDN GW2 115 in the DHCP message transmissions at step 440. A PMIP message exchange between the serving gateway 105 and the packet data network PDN GW2 115 is conducted in step 445, and new traffic is exchanged using the new quality of service or type of service in step 450.

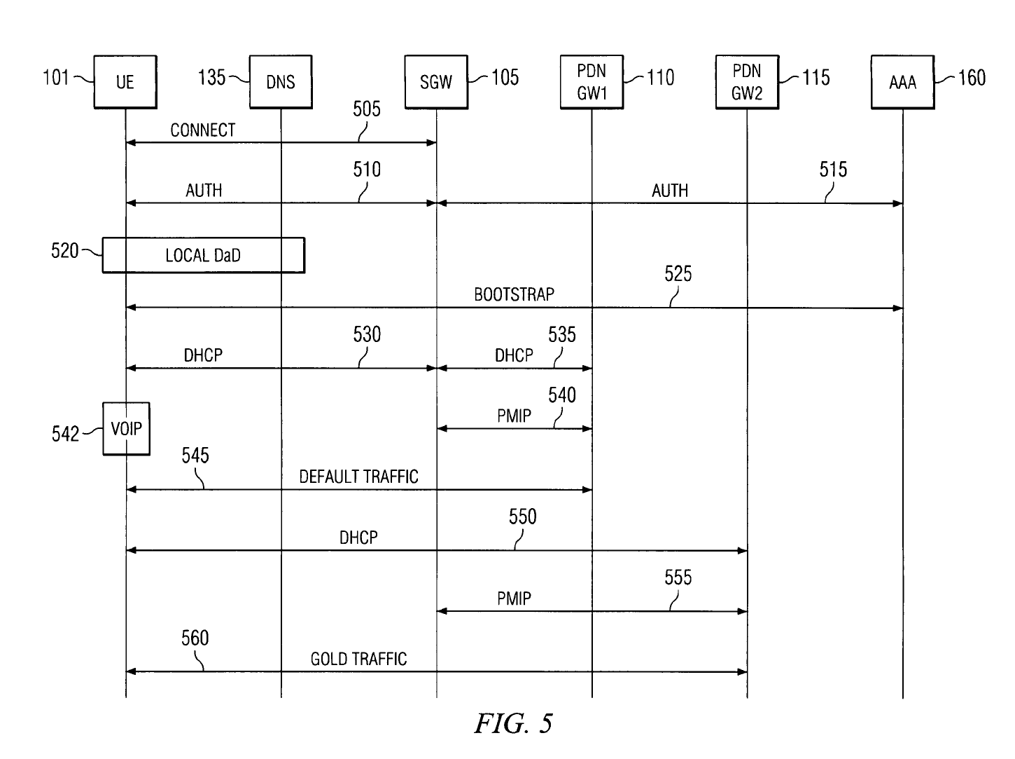

In FIG. 5, the identification and address information protocol is operated in Layer 3 using IPv6 messaging protocols, and is shown starting at step 505 when the user equipment 101 establishes its connections with the serving gateway 105. After step 505, the user equipment 101 is authenticated in step 510 by a communication to the serving gateway 105, and then step 515 from the serving gateway 105 to the AAA server 160. A Local Address DaD procedure is engaged at step 520 between the user equipment 101 and the DNS server 135 after the authentication steps 510 and 515.

A bootstrapping step 525 is performed between the user equipment 101 and the AAA server 160 during the attachment procedure where the identification and address information for the default packet data network gateway PDN GW1 110 is provided to the user equipment 101. This will be the “best effort” type of service supported for the user equipment 101. This PDN gateway GW1 will support the default quality of service or the default type of service for user equipment communications. In addition to the default addressing and identification information, the bootstrapping step 520 will also provide the address and identification information for the packet data network gateway PDN GW2 115 that supports various new quality of service or type of service to be made available to the user equipment 101 (e.g. VoIP, video streaming, video IP, real video, etc.).

The user equipment 101 will transmit a DHCP communication procedure with the serving gateway 105 in step 530, and the serving gateway 105 will engage with the packet data network PDN GW1 110 as the connection for the default services to be provided to the user equipment in step 535, A PMIP exchange between the serving gateway 105 and the packet data network PDN GW1 110 is conducted in step 540.

A voice call is initiated in step 542, and a different quality of service or type of service may be requested in the voice call, and default traffic is exchanged using the default quality or type of service in step 545. The user equipment 101 uses the address and identification information received from the earlier bootstrap communication at step 525 to communicate with the packet data network gateway PDN GW2 115 in the DHCP message transmissions at step 550. A PMIP message exchange between the serving gateway 105 and the packet data network PDN GW2 115 is conducted in step 555, and new traffic is exchanged using the new quality of service or type of service in step 560.

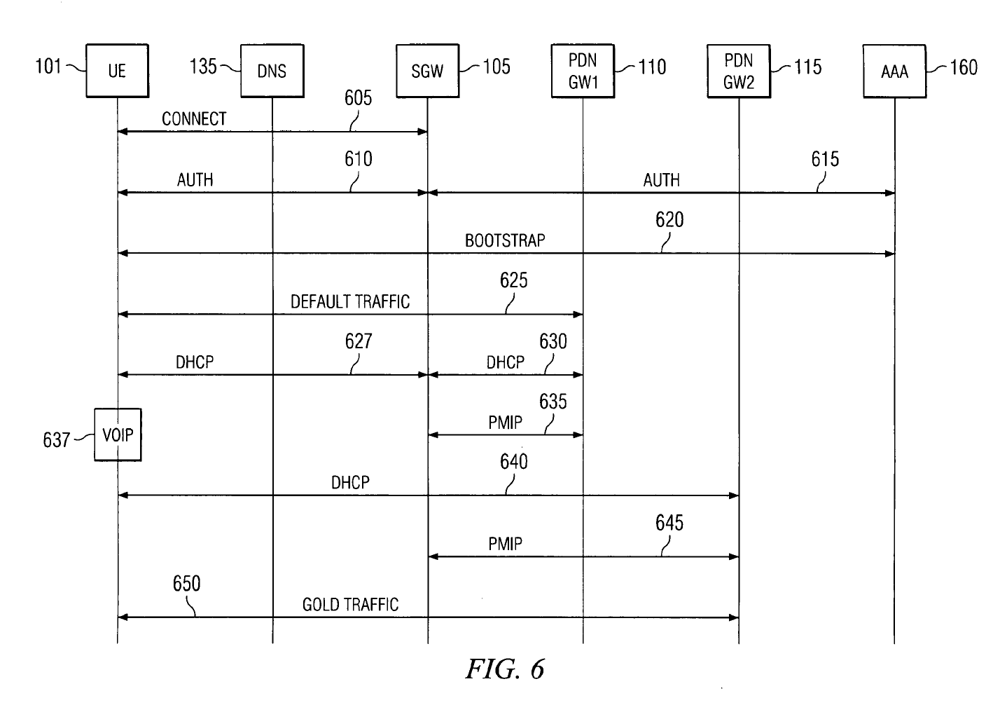

In FIG. 6, the identification and address information protocol is operated in Layer 2 using IPv4 messaging protocols, and is shown starting at step 605 when the user equipment 101 establishes its connections with the serving gateway 105. During step 605, the identification and address information for the default packet data network gateway PDN GW1 110 is provided to the user equipment 101. This will be the “best effort” type of service supported for the user equipment 101. This PDN gateway GW1 will support the default quality of service or the default type of service for user equipment communications. In addition to the default addressing and identification information, the connection step 605 will also provide the address and identification information for the packet data network gateway PDN GW2 115 that supports various new quality of service or type of service to be made available to the user equipment 101 (e.g. VoIP, video streaming, video IP, real video, etc.).

After step 605, the user equipment 101 is authenticated in step 610 by a communication to the serving gateway 105, and then step 615 from the serving gateway to the AAA server 160. A bootstrapping step 620 is performed between the user equipment 101 and the AAA server 160 during the attachment procedure.

In step 625, default traffic is exchanged between the user equipment 101 and the packet data network PDN GW1 110 using the default quality or type of service. The user equipment 101 will transmit a DHCP communication procedure with the serving gateway 105 in step 627, and the serving gateway 105 will engage with the packet data network PDN GW1 110 as the connection for the default services to be provided to the user equipment in step 630. A PMIP exchange between the serving gateway 105 and the packet data network PDN GW1 110 is conducted in step 635.

A voice call is initiated in step 637, and a different quality of service or type of service may be requested in the voice call. The user equipment 101 uses the address and identification information received from the AAA server 160 to communicate with the packet data network gateway PDN GW2 115 in the DHCP message transmissions at step 640. A PMIP message exchange between the serving gateway 105 and the packet data network PDN GW2 115 is conducted in step 645, and new traffic is exchanged using the new quality of service or type of service in step 650.

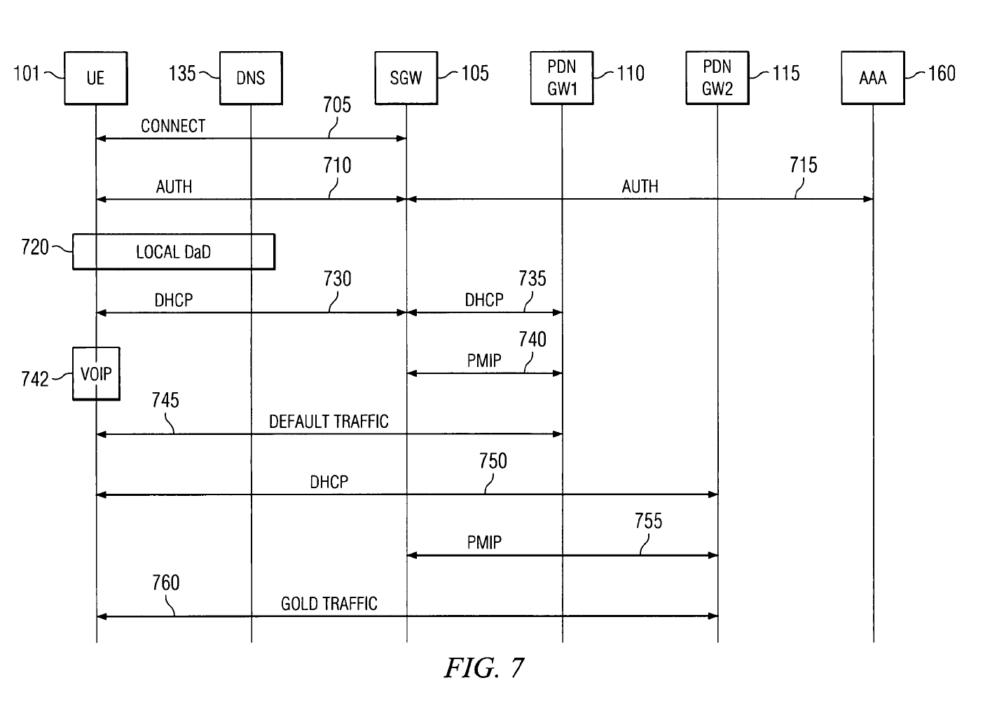

In FIG. 7, the identification and address information protocol is operated in Layer 2 using IPv6 messaging protocols, and is shown starting at step 705 when the user equipment 101 establishes its connections with the serving gateway 105. During step 705, the identification and address information for the default packet data network gateway PDN GW1 110 is provided to the user equipment 101. This will be the “best effort” type of service supported for the user equipment 101. This PDN gateway GW1 will support the default quality of service or the default type of service for user equipment communications. In addition to the default addressing and identification information, the connection step 705 will also provide the address and identification information for the packet data network gateway PDN GW2 115 that supports various new quality of service or type of service to be made available to the user equipment 101 (e.g. VoIP, video streaming, video IP, real video, etc.).

After step 705, the user equipment 101 is authenticated in step 710 by a communication to the serving gateway 105, and then step 715 from the serving gateway 105 to the AAA server 160. A Local Address DaD procedure is engaged at step 720 between the user equipment 101 and the DNS server 135 after the authentication steps 710 and 715.

The user equipment 101 will transmit a DHCP communication procedure with the serving gateway 105 in step 730, and the serving gateway 105 will engage with the packet data network PDN GW1 110 as the connection for the default services to be provided to the user equipment in step 735. A PMIP exchange between the serving gateway 105 and the packet data network PDN GW1 110 is conducted in step 740.

A voice call is initiated in step 742, and a different quality of service or type of service may be requested in the voice call, and default traffic is exchanged using the default quality or type of service in step 745. The user equipment 101 uses the address and identification information received from the earlier connection communication at step 705 to communicate with the packet data network gateway PDN GW2 115 in the DHCP message transmissions at step 750. A PMIP message exchange between the serving gateway 105 and the packet data network PDN GW2 115 is conducted in step 755, and new traffic is exchanged using the new quality of service or type of service in step 760.

The present invention also contemplates using a home agent IPv4 address extension to support the multiple PDN gateway GW addresses and identification information that support the different quality of services and types of services. Further, the HNP extension can also be used to list the unique identification and addressing information that support the different quality of services and types of services. In other protocols, the MAG or serving gateway will send a proxy binding update message with an indication of how many IPv4 addresses are needed and/or how many HNPs are needed to show the multiple PDN gateway GW addresses and identification that support the different quality of services and types of services.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention.

Having described the invention, we claim:

1. A method for providing identification and addressing information for one or more packet gateways that each support a different type of service through a coupled packet data network, comprising the steps of:
receiving a connection request message at a serving gateway server from a user equipment, said connection request message establishes a communication link between the user equipment and the serving gateway;
receiving a registration message at the serving gateway server from the user equipment having a first packet gateway addressing information relating to default type of service, said first packet gateway addressing information received by the user equipment during a bootstrap registration procedure and said serving gateway server assisting with the transmission of communications with the user equipment using the default type of service through the first gateway server identified in the first gateway addressing information; and,
receiving an anchor registration message at the serving gateway from a second packet gateway server, said second packet gateway identified by addressing information received by the user equipment from a domain name service server and said serving gateway server assisting with the registration of the second gateway server to support transmission of communications with the user equipment using a second type of service through the second gateway server identified in the second gateway addressing information.

2. The method in claim 1 wherein the system is operating under Layer 3 messaging protocols.

3. The method in claim 1 wherein the system is operating under IPv4 messaging protocols.

4. A method for providing identification and addressing information for one or more packet gateways that each support a different type of service through a coupled packet data network, comprising the steps of:
receiving a connection request message at a serving gateway server from a user equipment, said connection request message establishes a communication link between the user equipment and the serving gateway;
receiving a registration message at the serving gateway server from the user equipment having a first packet gateway addressing information relating to default type of service, said first packet gateway addressing information received by the user equipment from a domain name service server and said serving gateway server assisting with the transmission of communications with the user equipment using the default type of service through the first gateway server identified in the first gateway addressing information; and,
receiving an anchor registration message at the serving gateway from a second packet gateway server, said second packet gateway identified by addressing information received by the user equipment from a domain name service server and said serving gateway server assisting with the registration of the second gateway server to support transmission of communications with the user equipment using a second type of service through the second gateway server identified in the second gateway addressing information.

5. The method in claim 4 wherein the system is operating under Layer 3 messaging protocols.

6. The method in claim 4 wherein the system is operating under IPv6 messaging protocols.

7. A method for providing identification and addressing information for one or more packet gateways that each support a different type of service through a coupled packet data network, comprising the steps of:
receiving a connection request message at a serving gateway server from a user equipment, said connection request message establishes a communication link between the user equipment and the serving gateway;
receiving a registration message at the serving gateway server from the user equipment having a first packet gateway addressing information relating to default type of service, said first packet gateway addressing information received by the user equipment from an authentication server during a bootstrap procedure and said serving gateway server assisting with the transmission of communications with the user equipment using the default type of service through the first gateway server identified in the first gateway addressing information; and,
receiving an anchor registration message at the serving gateway from a second packet gateway server, said second packet gateway identified by addressing information received by the user equipment from the authentication server during the bootstrap procedure and said serving gateway server assisting with the registration of the second gateway server to support transmission of communications with the user equipment using a second type of service through the second gateway server identified in the second gateway addressing information.

8. The method in claim 7 wherein the system is operating under Layer 3 messaging protocols.

9. The method in claim 7 wherein the system is operating under IPv4 messaging protocols.

10. The method in claim 7 wherein the system is operating under IPv4 messaging protocols.

11. A method for providing identification and addressing information for one or more packet gateways that each support a different type of service through a coupled packet data network, comprising the steps of:
receiving a connection request message at a serving gateway server from a user equipment, said connection request message establishes a communication link between the user equipment and the serving gateway;
receiving a registration message at the serving gateway server from the user equipment having a first packet gateway addressing information relating to default type of service, said first packet gateway addressing information received by the user equipment from the serving gateway server during the connection procedure and said serving gateway server assisting with the transmission of communications with the user equipment using the default type of service through the first gateway server identified in the first gateway addressing information; and,
receiving an anchor registration message at the serving gateway from a second packet gateway server, said second packet gateway identified by addressing information received by the user equipment from the serving gateway server during the connection procedure and said serving gateway server assisting with the registration of the second gateway server to support transmission of communications with the user equipment using a second type of service through the second gateway server identified in the second gateway addressing information.

12. The method in claim 11 wherein the system is operating under Layer 2 messaging protocols.

13. The method in claim 11 wherein the system is operating under IPv4 messaging protocols.

14. The method in claim 11 wherein the system is operating under IPv4 messaging protocols.

15. A communications network supporting user equipment communications and provides identification and addressing information for one or more packet gateways that each support a different type of service through a coupled packet data network, comprising:
a serving gateway server that receives a connection request message from a user equipment, said connection request message establishes a communication link between the user equipment and the serving gateway and said serving gateway server receives a registration message from the user equipment having a first packet gateway addressing information relating to default type of service, said first packet gateway addressing information received by the user equipment during a bootstrap registration procedure and said serving gateway server assisting with the transmission of communications with the user equipment using the default type of service through the first gateway server identified in the first gateway addressing information; and,
said serving gateway server receives an anchor registration message from a second packet gateway server, said second packet gateway identified by addressing information received by the user equipment from a domain name service server and said serving gateway server assisting with the registration of the second gateway server to support transmission of communications with the user equipment using a second type of service through the second gateway server identified in the second gateway addressing information.

16. The network in claim 15 wherein the system is operating under Layer 3 messaging protocols.

17. The network in claim 15 wherein the system is operating under IPv4 messaging protocols.

18. A communications network supporting user equipment communications and provides identification and addressing information for one or more packet gateways that each support a different type of service through a coupled packet data network, comprising:
a serving gateway server that receives a connection request message at a serving gateway server from a user equipment, said connection request message establishes a communication link between the user equipment and the serving gateway and said serving gateway server receives a registration message at the serving gateway server from the user equipment having a first packet gateway addressing information relating to default type of service, said first packet gateway addressing information received by the user equipment from a domain name service server and said serving gateway server assisting with the transmission of communications with the user equipment using the default type of service through the first gateway server identified in the first gateway addressing information; and,
said serving gateway server receives an anchor registration message from a second packet gateway server, said second packet gateway identified by addressing information received by the user equipment from a domain name service server and said serving gateway server assisting with the registration of the second gateway server to support transmission of communications with the user equipment using a second type of service through the second gateway server identified in the second gateway addressing information.

19. The network in claim 18 wherein the system is operating under Layer 3 messaging protocols.

20. The network in claim 18 wherein the system is operating under IPv6 messaging protocols.

21. A communications network supporting user equipment communications and provides identification and addressing information for one or more packet gateways that each support a different type of service through a coupled packet data network, comprising:
a serving gateway server that receives a connection request message from a user equipment, said connection request message establishes a communication link between the user equipment and the serving gateway and said serving gateway server receives a registration message at the serving gateway server from the user equipment having a first packet gateway addressing information relating to default type of service, said first packet gateway addressing information received by the user equipment from an authentication server during a bootstrap procedure and said serving gateway server assisting with the transmission of communications with the user equipment using the default type of service through the first gateway server identified in the first gateway addressing information; and,
said serving gateway server receives an anchor registration message at the serving gateway from a second packet gateway server, said second packet gateway identified by addressing information received by the user equipment from the authentication server during the bootstrap procedure and said serving gateway server assisting with the registration of the second gateway server to support transmission of communications with the user equipment using a second type of service through the second gateway server identified in the second gateway addressing information.

22. The network in claim 21 wherein the system is operating under Layer 3 messaging protocols.

23. The network in claim 21 wherein the system is operating under IPv4 messaging protocols.

24. The network in claim 21 wherein the system is operating under IPv4 messaging protocols.

25. A communications network supporting user equipment communications and provides identification and addressing information for one or more packet gateways that each support a different type of service through a coupled packet data network, comprising:
a serving gateway server that receives a connection request message from a user equipment, said connection request message establishes a communication link between the user equipment and the serving gateway and receives a registration message at the serving gateway server from the user equipment having a first packet gateway addressing information relating to default type of service, said first packet gateway addressing information received by the user equipment from the serving gateway server during the connection procedure and said serving gateway server assisting with the transmission of communications with the user equipment using the default type of service through the first gateway server identified in the first gateway addressing information; and,
said serving gateway server receives an anchor registration message from a second packet gateway server, said second packet gateway is identified by addressing information received by the user equipment from the serving gateway server during the connection procedure and said serving gateway server assists with the registration of the second gateway server to support transmission of communications with the user equipment using a second type of service through the second gateway server identified in the second gateway addressing information.

26. The network in claim 25 wherein the system is operating under Layer 2 messaging protocols.

27. The network in claim 25 wherein the system is operating under IPv4 messaging protocols.

28. The network in claim 25 wherein the system is operating under IPv4 messaging protocols.
